(19) United States
(12) Patent Application Publication
(10) Pub. No.: US 2014/0144826 A1
(43) Pub. Date: May 29, 2014

(54) Magnetohydrodynamic Fluid Conditioner

(71) Applicant: Tina LaForce, Oklahoma City, OK (US)

(72) Inventor: Elmer Mason, (US)

(21) Appl. No.: 14/089,567

(22) Filed: Nov. 25, 2013

Related U.S. Application Data
(63) Continuation of application No. 12/835,383, filed on Jul. 13, 2010, now abandoned.
(60) Provisional application No. 61/225,133, filed on Jul. 13, 2009.

(51) Int. Cl. F02M 27/04

(52) U.S. Cl. CPC F02M 27/045
USPC 210/222

(57) ABSTRACT

An assembly for the magnetic treatment of fluids such as liquids and gases. The treatment device is a hollow outer sleeve having magnets along the inside wall of the outer sleeve. An inner fluid conduit with a weak magnetic response can be provided in the outer sleeve. Different magnet arrangements produce different effects in the fluid being treated. An even-number of magnets arranged with alternating polarities around the outer sleeve are called a buster, producing an effect that tends to “bust” fluid molecules by introducing mechanical stresses and turbulence in the fluid. One or more magnets arranged with uniform polarity are called an aligner, producing an effect that tends to align fluid molecules with the magnetic field produced by the magnets. One or more busters and one or more aligners are often used together to form a magnetic treatment assembly. Magnets may be permanent magnets or electromagnets. The numbers and types of busters and aligners are chosen depending on the composition of the fluid being treated and the volume of fluid flowing through the magnetic treatment assembly. The busting and aligning effect may be produced by a variety of magnetic treatment device geometries.

### CROSS-REFERENCE TO RELATED APPLICATIONS

The present application is a continuation of U.S. patent application Ser. No. 12/835,383, filed Jul. 13, 2010, which claims the benefit of U.S. Provisional Patent Application No. 61/225,133, filed Jul. 13, 2009, the contents of which are incorporated herein by reference.

### BACKGROUND

Blockages and flow reductions caused by the accumulation of scale and other deposits on the interior walls of water pipes, steam lines, and heat exchangers are well known maintenance problems. Similar problems can occur in gas and fuel lines and in sewage lines.

Piping system maintenance is a major, yet necessary, expense for operators of residential, commercial, and municipal piping installations, including: pipelines; pumping stations; water treatment plants; sewage systems; fuel plants; boiler and heat exchanger installations; steam generators; greenhouses; poultry, swine, and other agricultural facilities; irrigation networks; and the thousands of other infrastructure installations needed to convey water, sewage, liquid fuels, natural gas, and other fluids common to contemporary life. It is therefore desirable to identify technology capable of reducing or eliminating the need for labor-intensive fluid line cleaning and expensive pipeline and plumbing repairs or replacement. It is an objective of the present invention to treat fluids in such a way as to reduce or prevent blockages and flow restrictions. It is a further objective of the present invention to treat fluids by magnetic means with the objective of increasing the quality, utility, or efficacy of the fluid thus treated.

The magnetic treatment technology of this invention also may be applied to liquid and gaseous fuels with beneficial results. Magnetically treated fuels have a reduced tendency to form fuel line blockages, but magnetic fuel treatment has the particularly beneficial effect of causing fuel to burn more cleanly. Careful experiments have demonstrated that magnetically treated fuels burn more cleanly and more completely than the same fuel left untreated. As a result of magnetic fuel treatment, combustion temperatures are higher and the exhaust stream is characterized by a significant reduction in such undesirable combustion byproducts as particulate carbon, carbon monoxide, and oxides of nitrogen, which are known to be major contributors to poor air quality and environmental pollution generally.

The present invention achieves these and other beneficial effects by systematically applying magnetic field producing means using a combination of superficially similar, yet fundamentally different and carefully controlled, modules or configurations. For brevity, this specification will often use the word “magnet” rather than magnetic field producing means. Reference to a magnet is to be understood to include a permanent magnet, an electromagnet, or any other structure capable of producing a useful magnetic field. Each modular arrangement has its own particular geometry of magnets to achieve a particular result in the fluid being treated. While each modular arrangement may be beneficial by itself in certain circumstances, a controlled treatment sequence provided by an engineered assembly containing the proper combinations of these modules ordinarily yields a result superior to that obtained by using any single module by itself.

Experimentation has confirmed that, when the magnet is a permanent magnet, a combination of different permanent magnet types often produces a result superior to that obtained using only a single permanent magnet type. For example, experimental results have shown that a ferrite magnet produces longer flux lines capable of operating at greater effective distances than many other permanent magnets. Neodymium magnets, which produce a more intense magnetic field than ferrite magnets, typically produce shorter flux lines with a somewhat lesser effective distance than a ferrite magnet. These different magnetic field characteristics can often be combined to good effect when magnets of both types are used in sequentially staged modules, or in compound treatment modules employing magnets of more than one type. Magnets may comprise ferrite permanent magnets, neodymium permanent magnets, or other magnet types depending on the application. AlNiCo and samarium cobalt permanent magnets may also be used, and other permanent magnet compositions are available. The composition of the permanent magnet is not a limitation of the invention. Most permanent magnets will be used as generally rectangular bars of material, but it is also possible to obtain beneficial results by shaping the permanent magnet in specific ways, as by finishing the ends of permanent magnets to obtain a chisel-shaped profile. Electromagnet geometry may also be manipulated to obtain beneficial effects, and this invention is not limited to any particular magnet geometry.

It is well known that magnets have two opposite poles, usually called the North pole and the South pole. When discussing magnet geometries, it is often convenient to describe a magnet as having a magnetic equator. The magnetic equator is a conceptual surface separating the magnet's North and South poles and, in many geometries, is substantially parallel to both poles. This is a convenient concept when dealing with button magnets, rectangular or square bar magnets, and similar structures commonly used for magnetic fluid treatment.

This specification uses the word “fluid” in its most general sense, referring to either a liquid or gaseous state of matter. It will occasionally be necessary to be specific about the fluid being treated—for example, when the specific fluid is a liquid hydrocarbon fuel—but fluid, as used in this specification, may be either a liquid or gas. Similarly, it is well known that magnets may be permanent magnets, electromagnets, or even naturally-occurring magnetized mineral bodies such as lodestone. As used herein, magnets producing a magnetic field will be understood to include permanent magnets, electromagnets, and any other source of magnetic field energy.

It is instructive to use an imaging aid known as magnetic imaging paper, exemplified by Magne-View Film® produced by Magne-Rite, Inc., 17625 East Euclid Avenue, Spokane, Wash., 99216. This visualization aid may be used to identify changes in magnetic polarity. This specification describes some materials as having weak, little, or no magnetic response, and other materials as having a strong magnetic response. The notion that a material has a weak or a strong magnetic response is an intuitive, qualitative description of a physical property formally known as magnetic permeability. The magnetic permeability, p, of a material is a physical parameter relating the mechanical force between two currents to their magnitudes and geometrical configurations. It is common to express magnetic permeability as the product of two terms. The first term is the fundamental physical constant known as the permeability of free space, symbol μ₀, having an exact (defined) magnitude of 4π×10⁻⁷ H/m in SI units. The second term is the relative permeability of the material, μ_{R}, a dimensionless quantity expressing a material's magnetic permeability relative to the permeability of free space (μ=μ_{R}μ₀).

Equivalently, a material's relative permeability is the ratio of the material's magnetic permeability to the permeability of free space (μ_{R}=μ/μ₀). Most materials have a relative permeability of substantially unity (substantially 1), meaning their exhibited magnetic response is essentially that of free space (μ=μ_{R}μ₀≈1μ₀≈μ₀). For purposes of this application, a material having relative permeability of substantially unity (typically in the range 0.95 to 1.05) is said to exhibit weak (little or no) magnetic response. A relative few materials including iron, nickel, steels (excepting a very limited number of specialty steel alloys), ferrites, and certain specialty alloys such as mu-metal and permalloy have large relative permeabilities spanning a very wide range (2-4,000 or more). Relative permeability often varies with frequency, temperature, geometry, and other influences beyond the scope of this application. Materials having a relative permeability substantially greater than unity are said to exhibit a strong magnetic response.

### SUMMARY

In a first embodiment the present invention comprises an assembly for magnetically treating a fluid. The assembly comprises at least one buster module, each buster module comprising an outer sleeve, a fluid conduit having a central axis, and an even number of magnets. Each magnet has a first pole and a second opposite pole, the poles separated by a magnetic equator. The conduit is disposed within the sleeve forming an annular space between the conduit and the sleeve. The magnets are symmetrically disposed in the annular space with their magnetic equators parallel to the central axis of the conduit. The magnets are oriented such that, for any magnet disposed such that its first pole is positioned adjacent the conduit, an adjacent magnet is disposed such that its second pole is positioned adjacent the conduit.

In an alternative embodiment the present invention is directed to an assembly for magnetically treating a fluid. The assembly comprises at least one buster module and at least one aligner module. Each buster module comprises an outer sleeve, an inner fluid conduit having a central axis, and an even number of magnets. Each magnet has a first pole and a second opposite pole, the poles separated by a magnetic equator. The conduit is disposed within the sleeve forming an annular space between the conduit and the sleeve. The magnets are symmetrically disposed in the annular space with their magnetic equators parallel to the central axis of the conduit. The magnets are oriented such that, for any magnet disposed such that its first pole is positioned adjacent the conduit, an adjacent magnet is disposed such that its second pole is positioned adjacent the conduit. Each aligner module comprises an outer sleeve, an inner fluid conduit having a central axis, and one or more magnets each having a first pole and a second opposite pole. The poles of the magnets are separated by a magnetic equator. The conduit is disposed within the sleeve forming an annular space between the conduit and the sleeve. The magnets are symmetrically disposed in the annular space with their magnetic equators parallel to the central axis of the conduit. The magnets are oriented such that each magnet has the same first pole or second pole placed nearest the conduit.

In yet another embodiment the invention is directed to an assembly for magnetically treating wastewater. The assembly comprises a perforated pipe adapted to screen wastewater, a buster module, an aligner module, and a pump having an inlet side and an outlet side. The buster module comprises an outer sleeve, an inner fluid conduit having a central axis, and an even number of magnets each having a first pole and a second opposite pole, the poles separated by a magnetic equator. The inner conduit is disposed within the sleeve forming an annular space between the conduit and the sleeve. The magnets are symmetrically disposed in the annular space with their magnetic equators parallel to the central axis of the conduit and the magnets are oriented such that for any magnet disposed such that its first pole is positioned adjacent the conduit an adjacent magnet is disposed such that its second pole is positioned adjacent the conduit. The aligner module comprises an outer sleeve, an inner fluid conduit having a central axis, and one or more magnets each having a first pole and a second opposite pole, the poles separated by a magnetic equator. The inner conduit is disposed within the sleeve forming an annular space between the conduit and the sleeve. The one or more magnets are symmetrically disposed in the annular space with their magnetic equators parallel to the central axis of the conduit and the magnets are oriented such that for each magnet has the same first pole or second pole placed nearest the conduit. A first end of the fluid conduit of the buster module is connected to the perforated pipe. A second end of the fluid conduit of the buster module is connected to a first end of the fluid conduit of the aligner module. A second end of the fluid conduit of the aligner module is connected to the inlet side of the pump.

In still another embodiment the present invention is directed to an assembly for magnetically treating a fluid. The assembly comprises a housing, an inner support frame, a first magnet and a second magnet, a first conduit and a second conduit, an inlet fluid conduit, and an outlet fluid conduit. The housing has a top surface and bottom surface, the top and bottom being parallel. The support frame is disposed within the housing and comprises first and second parallel sides. The magnets each have a first pole and a second pole, the poles separated by a magnetic equator. The first magnet is supported on an exterior surface of the support frame such that the first pole is adjacent the first parallel side of the support frame and the second pole is adjacent the top surface of the housing. The second magnet is supported on an exterior surface of the support frame such that the first pole is adjacent the second parallel side of the support frame and the second pole is adjacent the bottom surface of the housing. The first conduit is disposed within the housing adjacent a first side of the support frame. The second conduit is disposed within the housing adjacent a second side of the support frame. The inlet fluid conduit is connected to a first end of the first conduit and a first end of the second conduit. The outlet fluid conduit is connected to a second end of the first conduit and a second end of the second conduit.

In another alternative embodiment, the invention is directed to an assembly for magnetically treating a fluid. The assembly comprises at least one buster module where the buster module comprises an outer sleeve and an even number of magnets. The outer sleeve has an inner wall. The magnets each have a first pole and a second opposite pole. The magnets are symmetrically disposed within the outer sleeve such that for any magnet disposed such that its first pole is positioned adjacent the interior wall of the outer sleeve, an adjacent magnet is disposed such that its second pole is positioned adjacent the inner wall of the outer sleeve.

### BRIEF DESCRIPTION OF THE DRAWINGS

FIG. 1 is a sectional view of magnets in a representative buster module for use in the present invention.

FIG. 2 is a sectional elevation through a diameter of the representative buster module shown in FIG. 1.

FIG. 3 is a sectional view of magnets in a representative aligner module for use in the present invention.

FIG. 4 is a sectional elevation through a diameter of the representative aligner module shown in FIG. 3.

FIG. 5 is a sectional elevation of a treatment assembly built in accordance with the present invention.

FIG. 5A is a sectional view of the assembly from FIG. 5 taken along the cut-line A-A′ showing magnet locations and corresponding images obtained using magnetic imaging paper.

FIG. 5B is a sectional view of the assembly from FIG. 5 taken along the cut-line B-B′ showing magnet locations and corresponding images obtained using magnetic imaging paper.

FIG. 5C is a sectional view of the assembly from FIG. 5 taken along the cut-line and C-C′ showing magnet locations and corresponding images obtained using magnetic imaging paper.

FIG. 6 is a partial view of magnets on a mounting plate for use with the second embodiment of the invention.

FIG. 7 is an exploded view of the mounting plates shown in FIG. 6.

FIG. 8 is a sectional elevation of the second embodiment of the invention using the mounting plates of FIG. 7.

FIG. 9 is a sectional view along lines D-D′ of the embodiment of FIG. 8.

FIG. 10 is a sectional view of the third embodiment of the invention.

FIG. 11 is a sectional view of a compound buster assembly for use with the third embodiment shown in FIG. 10.

FIG. 12A is a top view of the assembly and aligner used in the embodiment shown in FIG. 10.

FIG. 12B is a front elevation of the assembly and aligner used in the embodiment shown in FIG. 10.

FIG. 12C is a side elevation of the assembly and aligner used in the embodiment shown in FIG. 10.

FIG. 13A is a top orthographic presentation of an alternative embodiment of the present invention used to treat domestic water lines.

FIG. 13B is a front elevation of the embodiment of FIG. 13A.

FIG. 13C is a side elevation of the embodiment of FIG. 13A.

FIG. 14 is a sectional view of the embodiment of FIG. 13A taken along lines E-E′.

FIG. 15 is sectional view of magnets in a representative buster module for use in the fifth embodiment of the invention.

FIG. 16 is a sectional view of magnets in a representative aligner module for use in the fifth embodiment of the invention.

FIG. 17 is a sectional view of magnets in a representative six-element magnetic treatment module.

FIG. 18A is a side view of a treatment assembly and outer jacket of a fifth embodiment of the invention.

FIG. 18B is a sectional view of the treatment assembly of FIG. 18A.

FIG. 19 is a side elevation of a treatment assembly according to a sixth embodiment of the invention.

FIG. 19A is a sectional view of the assembly of FIG. 19 taken along the cut-line A-A′.

FIG. 19B is a sectional view of the assembly of FIG. 19 taken along the cut-line B-B′.

FIG. 19C is a sectional view of the assembly of FIG. 19 taken along the cut-line C-C′.

### DETAILED DESCRIPTION

The present invention is directed to fluid treatment apparatuses for a variety of applications. The apparatuses include a plurality of magnets arranged geometrically in ways causing magnetic forces to reinforce each other or to oppose each other. As fluid molecules pass through the fluid treatment apparatus, they are exposed to intense magnetic fields which cause the fluid molecules to rotate into alignment with the field. In some cases, intense oppositely-directed forces encourage the fluid molecules to shear or otherwise modify their geometry. The former effect—that of forcing fluid molecules to align themselves with the device's magnetic field—gives the name “aligner” to the modular assembly specifically designed to enhance the alignment effect. Other magnet geometries are responsible for the latter effect, exposing the fluid molecules to oppositely-directed forces which produce more violent behaviors, introducing turbulence into the fluid and also introducing molecular level stresses encouraging larger molecules to break into smaller molecular fragments. The modular assembly producing these effects is called a “buster,” for it encourages larger molecules to break or “bust” into smaller fragments.

### Buster Module

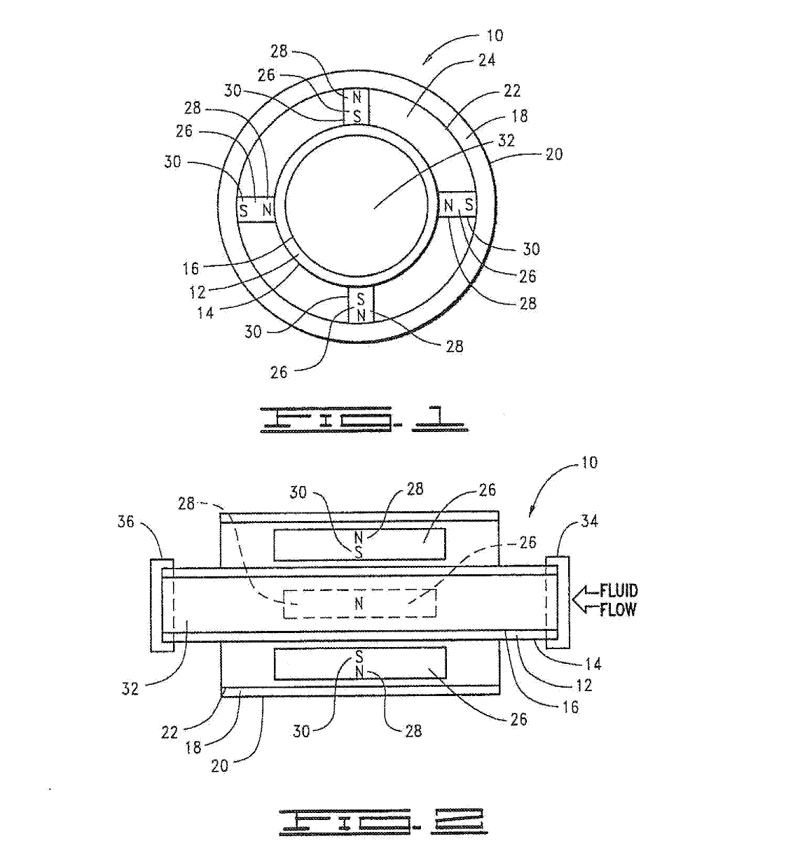

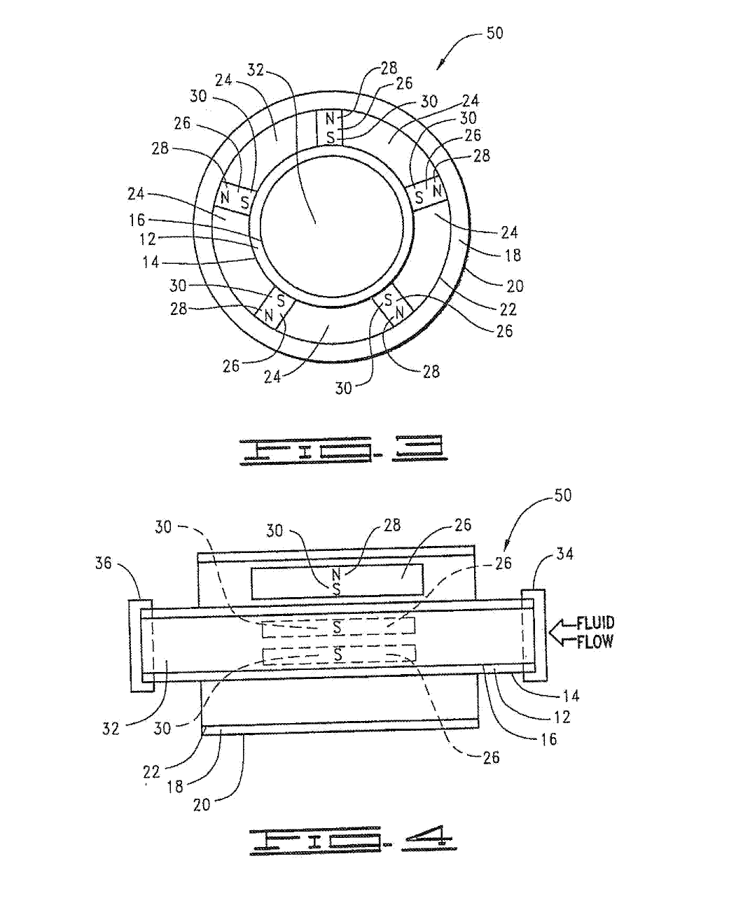

With reference to the drawings in general and to FIGS. 1 and 2 in particular, there is shown therein a representative embodiment of a buster module 10. Buster module 10 features a fluid conduit 12 having an outer wall 14 and an inner wall 16, shown as a section of pipe with circular cross-section for purposes of illustration. Fluid conduit 12 carries the fluid being treated and ordinarily is formed of material which is chemically compatible with the fluid and which has little or no magnetic response. The buster module 10 features an outer sleeve 18, shown as a section of pipe with circular cross-section for purposes of illustration. Outer sleeve 18 has an outer wall 20 and an inner wall 22. Outer sleeve 18 will ordinarily be made of mild steel or other material with a strong magnetic response. Outer sleeve 18 should be formed without welding or other high-heat fabrication operations. Inner wall 22 of outer sleeve 18 is of larger diameter than the outer wall 14 of fluid conduit 12, thereby forming an annular space 24 between the fluid conduit 12 and outer sleeve 18. Annular space 24 preferably contains an even-numbered plurality of magnets 26. Magnets 26 are preferably a permanent magnet, an electromagnet, or other means of producing a magnetic field. More preferably, four magnets 26 are used, being shown in FIG. 1 as bar-type permanent magnets. Magnets 26 are arranged with their respective major axes parallel to the axis of fluid conduit 12. The magnets 26 are arranged in a radially symmetric equidistantly spaced relationship in annular space 24. Each magnet 26 has a North pole 28 and a South pole 30. The innermost pole faces of the magnets 26 are maintained in close proximity to the outer wall 14 of fluid conduit 12, while the outermost pole faces of the magnets are maintained in close proximity to the inner wall 22 of outer sleeve 18.

Buster module 10 features magnets 26 which are arranged to present alternating polarities to the fluid conduit 12. In FIG. 1, the uppermost magnet 26 presents its South pole 30 to fluid conduit 12. Proceeding from this location in a clockwise manner, it is seen that the subsequent magnets 26 present a North pole 28, a South pole 30, and a North pole 28 to fluid conduit 12. Preferably, the magnets 26 in a buster module 10 ordinarily will be devices having the same nominal dimensions and will be devices of the same type. For example, if a single buster module 10 were formed using permanent magnets, all magnets 26 used in that single buster module 10 ordinarily would all have the same nominal dimensions and ordinarily would all have the same composition (in this example, all four would more preferably have the same AlNiCo, ferrite, neodymium, or samarium cobalt composition). While the use of magnets 26 with common dimensions and composition in a single buster module 10 provides desirable manufacturing advantages, the use of common dimensions and composition is not a requirement of, nor is it a limitation of, the invention.

Fluid conduit 12 defines an inner annular volume 32 for product flow. Fluid conduit 12 is normally provided with inlet fitting 34 and outlet fitting 36 (shown in FIG. 2) which permit fluid conduit 12 to be inserted into, or removed from, a piping system (not shown) to which mating fittings are affixed. The exact natures of inlet fitting 34 and outlet fitting 36 are determined by design choice. In the embodiment shown in FIGS. 1 and 2, all components of the buster apparatus are external to the fluid conduit 12 and the inner annular volume 32 for product flow is unobstructed.

### Aligner Module

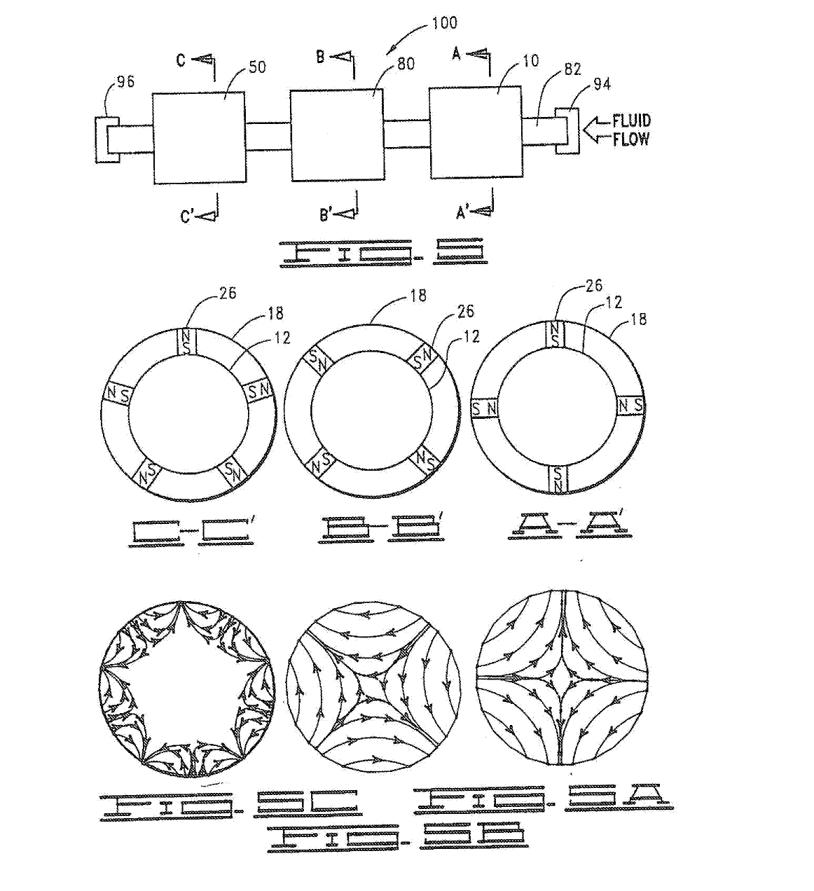

Referring now to FIGS. 3 and 4, shown therein is a representative embodiment of an aligner module 50. The aligner module 50 is preferably structurally similar to the buster module 10, as just described, with the primary difference between the two module types being the orientation of the magnets 26. For this reason, many of the same reference numerals are used in the preceding buster module 10 description and the aligner module 50 description which follows.

Aligner module 50 features a fluid conduit 12 having an outer wall 14 and an inner wall 16, shown as a section of pipe with circular cross-section for purposes of illustration. Fluid conduit 12 carries the fluid being treated and ordinarily is formed of material which is chemically compatible with the fluid and which has little or no magnetic response. The aligner module 50 features an outer sleeve 18, shown as a section of pipe with circular cross-section for purposes of illustration. Outer sleeve 18 has an outer wall 20 and an inner wall 22. Outer sleeve 18 will ordinarily be made of a mild steel or other material with a strong magnetic response. Outer sleeve 18 should be formed without welding or other high-heat fabrication operations. Inner wall 22 of outer sleeve 18 is of larger diameter than the outer wall 14 of fluid conduit 12, thereby forming annular space 24 between the fluid conduit 12 and outer sleeve 18. Annular space 24 contains a plurality of magnets 26, which may be either an even or an odd number of magnets. Preferably, five bar-type permanent magnets are used. The magnets 26 are arranged with their respective major axes parallel to the axis of fluid conduit 12. The magnets 26 are arranged in a radially symmetric equidistantly spaced relationship in annular space 24. Each magnet 26 has a North pole 28 and a South pole 30. The innermost pole faces of the magnets 26 are maintained in close proximity to the outer wall 14 of fluid conduit 12, while the outermost pole faces of the magnets 26 are maintained in close proximity to the inner wall 22 of outer sleeve 18.

Aligner module 50 features magnets 26 arranged to present the same polarity to the fluid conduit 12. In the embodiment of FIG. 3, all magnets 26 present their South pole 30 to fluid conduit 12. Preferably, the magnets 26 in an aligner module 50 ordinarily will be devices having the same nominal dimensions and will be devices of the same type, as similarly discussed with respect to the buster module 10.

Fluid conduit 12 defines an inner annular volume 32 for product flow. Fluid conduit 12 is normally provided with inlet fitting 34 and outlet fitting 36 (shown in FIG. 4) which permit fluid conduit 12 to be inserted into, or removed from, a piping system (not shown) to which mating fittings are affixed. In the embodiment shown in FIGS. 3 and 4, all components of the aligner apparatus are external to the fluid conduit 12 and the inner annular volume 32 for product flow is unobstructed.

### Magnetic Treatment Assemblies

The buster module 10 and aligner module 50 previously described are fundamental functional units, each with a different effect on the fluid being treated. A single buster module 10 can be used by itself to treat a fluid line, and a single aligner module 50 can be used by itself to treat a fluid line. In the embodiments, one or more buster modules and one or more aligner modules are combined in various ways to create a magnetic fluid treatment assembly in accordance with the present invention.

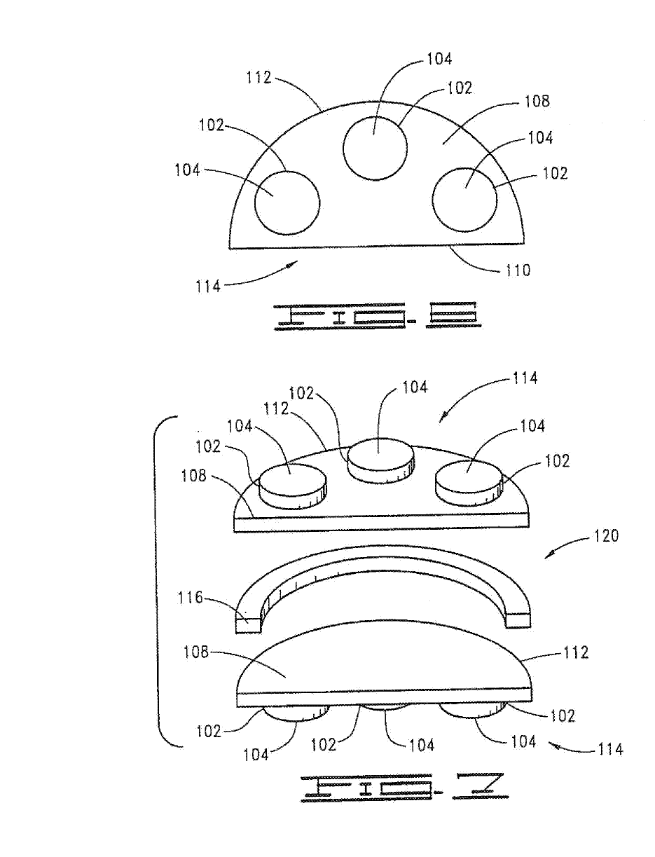

Referring now to FIG. 5, shown therein is an illustration of an embodiment of the invention for the magnetic treatment of water and other liquids, such as water treatment unit for use in a domestic or light industrial main water feed line. Magnetic fluid treatment assembly 100 is formed using a first buster module 10, a second buster module 80, and a single aligner module 50 which share a common fluid conduit 82. Preferably, the second buster module 80 is rotated 45° relative to the first buster module 10. The fluid conduit 82 has an inlet fitting 94 and outlet fitting 96 allowing the magnetic fluid treatment module 100 to be adaptively coupled to a water piping system (not shown). Use of a common fluid conduit 82 is a matter of design choice which eliminates the manufacturing and material expenses of multiple inlet fittings 34 and multiple outlet fittings 36. The use of individual fluid conduits 12 for individual modules, the use of a common fluid conduit 82 for multiple modules, or the use of multiple fluid conduits (not shown) in various other combinations and permutations are contemplated by the invention.

Fluid flow is indicated schematically by the arrow near the inlet fitting 94. The fluid to be treated enters the magnetic fluid treatment assembly 100 by means of the inlet fitting 94, flows through the first buster module 10, then flows through the second buster module 80, then flows through the aligner module 50, and then exits the magnetic fluid treatment assembly 100 by means of outlet fitting 96. An individual fluid molecule passing through the assembly 100 is exposed to the magnetic field characteristic of buster module 10, followed by a brief transit through a pipe segment with little or no external magnetic field (corresponding to the intermodule gap), followed by exposure to the magnetic field characteristic of buster module 80, followed by exposure to another segment with little or no external magnetic field, followed by exposure to the magnetic field characteristic of aligner module 50.

Section A-A′ in FIG. 5 is a cross-section taken through buster module 10, illustrating the location and polarities of the magnets 26. Immediately below Section A-A′ is an image of the magnetic field inside buster module 10 when viewed using Magne-View Film® produced by Magne-Rite, Inc., 17625 East Euclid Avenue, Spokane, Wash., 99216. The film produces an image in which the light color represents a magnetic field null, or an area of substantially neutral magnetic field intensity. It is important to note the orientation of the permanent magnets in the sectional sketch and the corresponding features on the film image.

Section B-B′ in FIG. 5 is a cross-section taken through buster module 80. The physical locations of the permanent magnets 26 are noted in the cross-section. It will be seen that the orientation of the magnetic field pattern produced by the permanent magnets is also rotated 45°. Thus, a molecule in the fluid which may have passed through the null of buster module 10 will experience a maximum field when passing through buster module 80.

Section C-C′ in FIG. 5 is a cross section taken through aligner module 50. This cross-section illustrates the use of five, rather than four, permanent magnets 26. However, the film image reflects the dramatically different magnetic field produced by the aligner module 50 compared to buster module 10 and buster module 80. Notice that the aligner module 50 produces an intense single-polarity field which is radially symmetric with the axis of fluid conduit 12 and which has maximum intensity along the main axis of fluid conduit 12. The magnetic field intensity profile is also a good approximation of the fluid velocity profile characteristic of uniform fluid flow through a circular pipe. This is to say, the aligner arrangement produces maximum magnetic field in the portion of the pipe which carries the largest proportion of water molecules to be treated.

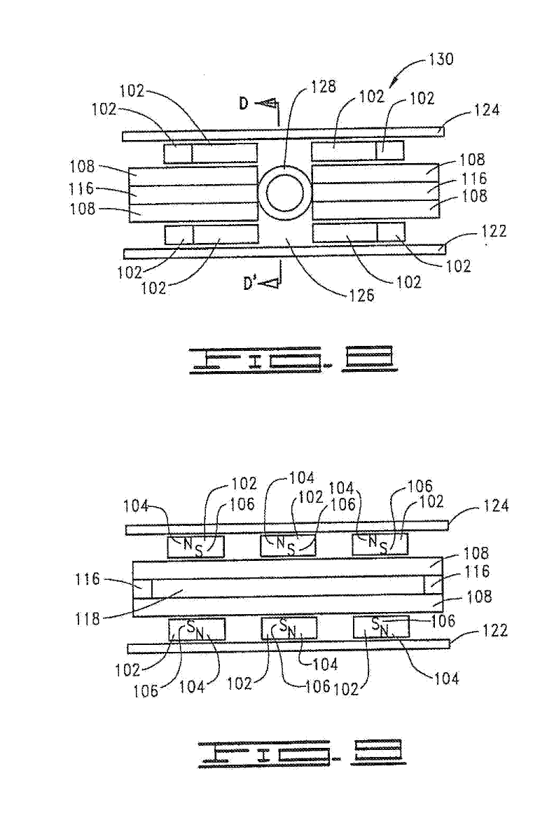

Turning now to FIGS. 6-9, the second embodiment of the invention shown is a clamp-on or bolt-on magnetic fuel treatment device, preferably for use on the fuel line of an internal combustion engine. The fluid to be treated is typically a liquid hydrocarbon fuel such as gasoline or diesel fuel.

The fuel treatment assembly 130 of the present embodiment comprises a plurality of mounting plate assemblies 114. Each mounting plate assembly comprises one or more permanent magnets 102 attached to one side of a semicircular mounting plate 108 made of material with a high magnetic response, typically a mild steel. Preferably, three magnets 102 are mounted on the plate 108. More preferably, the permanent magnets 102 are oriented so their South poles 106 (shown in FIG. 9) are immediately adjacent the semicircular mounting plate 108.

The semicircular mounting plate 108 comprises a semicircle having an arcuate edge 112 and a straight edge 110. Two outer magnets 102 are placed near the intersections of the arcuate edge 112 with the straight edge 110, with the outer magnets 102 being placed so the straight edge 110 of the semicircular mounting plate 108 is substantially tangent to the two outer magnets 102. The third magnet 102 is between and roughly equidistant from the two outer magnets 102. The third magnet 102 is set back from the semicircular mounting plate's 108 straight edge 110 by a distance substantially equal to the magnet's 102 radius. The three magnets 102 are separated from one another by small gaps, as shown.

FIG. 7 is an exploded view of a semicircular cavity 118 formed using two mounting plate assemblies 114. The two mounting plate assemblies 114 are separated by a generally semicircular spacer 116 matching the arcuate edge 112 profile of the semicircular mounting plates 108, but which has a substantially uniform wall thickness and relatively large inside radius. When these components are joined together, they form a central semicircular cavity 118 (shown in FIG. 9) surrounded by permanent magnets 102. Because the permanent magnets 102 all present their South pole 106 faces to the walls of the semicircular cavity 118, the semicircular cavity 118 is penetrated by an intense magnetic field. The assembly shown in FIG. 7 represents a magnetic treatment half 120 for the present embodiment.

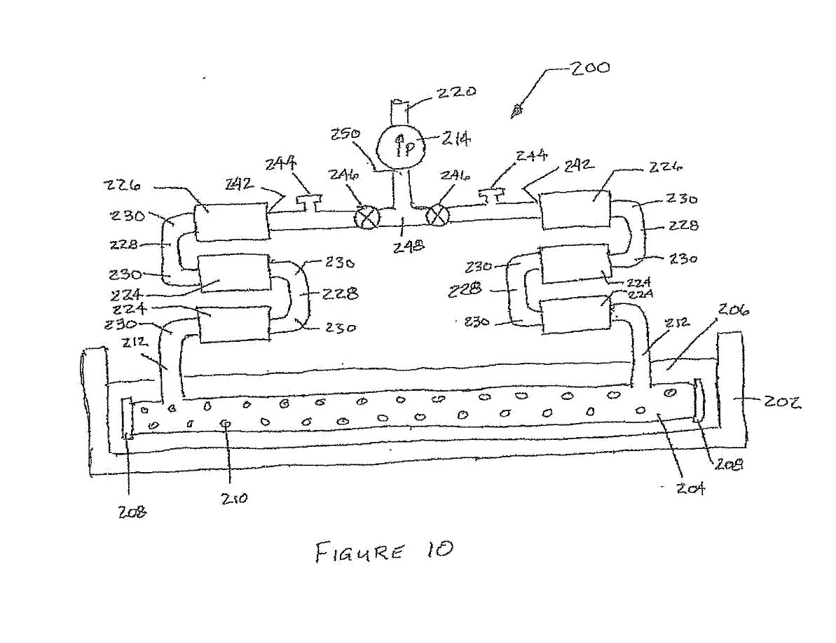

As shown in FIGS. 8 and 9, assembly of the magnetic fuel treatment device 130 continues by placing two magnet treatment halves 120 on a bottom outer plate 122. A substantially linear gap 126 separates the parallel straight edges 110 of the magnetic treatment halves 120. The bottom outer plate 122 is preferably made of material with a high magnetic response, typically a mild steel A fluid conduit 128, preferably a piece of round tubing, is positioned in the linear gap 126. Fluid conduit 128 is preferably made of material with little or no magnetic response and must be selected for chemical compatibility with the fluid traveling through the conduit and for mechanical properties compatible with the requirements of the intended installation.

Magnetic fuel treatment device 130 further comprises a top outer plate 124, which covers the remaining permanent magnets 102. This construction results in two interior, generally D-shaped, semicircular cavities 118 immediately adjacent the South poles 106 of a total of twelve permanent magnets 102. The North poles 104 of the permanent magnets 102 are immediately adjacent either the top outer plate 124 or bottom outer plate 122. The outer plates 122 and 124 act as magnetic field concentrators, driving magnetic flux into the fluid conduit 128. Fluid conduit 128 passes through the linear gap 126 formed by the straight edges 110 of the magnetic treatment halves 120. The interior semicircular cavities 118 are immediately adjacent the diameter of the fluid conduit 128, forcing maximum magnetic flux into the interior of fluid conduit 128 and treating the fluid flowing therein.

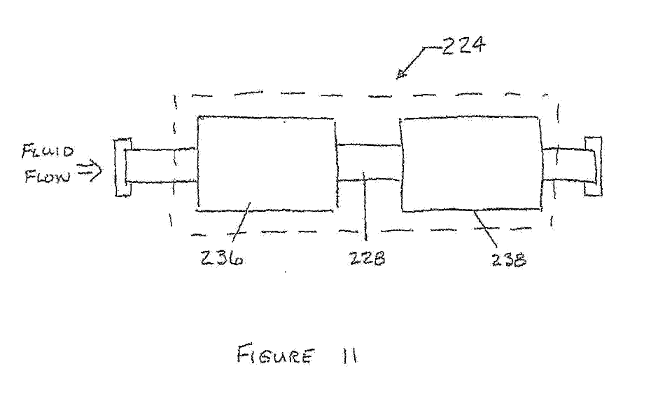

The third embodiment of the present invention, shown in FIG. 10, was developed to deal with the pumping and cleaning of lagoons and sumps typical of those used in commercial pork production operations. When floors of structures in such operations are cleaned, the wastewater must be removed and treated. However, pumping the wastewater often results in blockages that the present embodiment serves to clear or prevent.

FIG. 10 is a sectional view illustrating the components of a swine wastewater treatment apparatus 200 consisting of buster and aligner modules. The sump or lagoon 202, typically made of poured concrete, receives and accumulates waste material from one or more surface hut structures (not shown). A perforated or slotted pipe 204 is situated near the bottom of the sump 202 and is covered by wastewater 206. Ends of the perforated pipe are sealed by caps 208, forcing the wastewater 206 to pass though the perforations or slots 210 as it is pulled into the wastewater line 212. This is done largely to prevent gross blockages by placental membranes and the like which would otherwise interfere with the pump impeller. Gross blockages can be cleared by water from high-pressure jets and strainers.

Wastewater 206 is removed from the sump 202 by applying power to the pump 214, whose rotating impeller vanes (not shown) create suction, or partial vacuum, causing wastewater 206 to be pulled through the perforated pipe 204 and then through one or more buster assemblies and one or more aligner assemblies before the wastewater 206 passes through the pump 214 into the discharge line 220. Parallel paths are desirable to reduce the likelihood of shutdown due to blockage and to increase the exposure of the wastewater stream to the magnetic fields of busters and aligners.

The treatment apparatus 200 comprises a plurality of compound buster assemblies 224, referred to as such because they are composed of multiple buster assemblies similar to those already described, shown in FIG. 11. The present embodiment preferably uses two-inch (2″) diameter heavy wall PVC line as general piping and fluid conduit (212, 220, 228). The compound buster 224 and aligner 226 assemblies are preferably connected to one another by 2-10 inch pipe 228 and 2-inch large-diameter elbows 230 called “sweeps” which introduce mechanical turbulence while directing fluid flow from one magnetic treatment assembly to the next. The inlet 232 of the first compound buster assembly 224 is connected near a first end of the perforated pipe 204. A similarly constructed parallel path is connected near a second end of the perforated pipe 204.

The installation for the treatment assembly 200 comprises a first compound buster unit 224 containing a first ferrite buster module 236, a buster module as previously taught in which the magnets are ferrite permanent magnets, and a first neodymium buster module 238, a buster module as previously taught in which the magnets are neodymium permanent magnets. The first compound buster 224 is followed by a second compound buster unit 224 containing a second ferrite buster module 236 in which the magnets are ferrite permanent magnets, and a second neodymium buster module 238 in which the magnets are neodymium permanent magnets. The second compound buster unit 224 is followed by a ferrite aligner assembly 226, an aligner assembly discussed below in which the magnets are ferrite permanent magnets. Outlet fittings 242 of the aligner units 226 are connected to capped cleanout fittings 244. Preferably, the caps can be removed to provide access allowing piping 228 to be backflushed for cleaning. Capped cleanout fittings 244 are connected to cutoff valves 246 allowing the wastewater tee 248 to be isolated from the pump suction inlet 250, which facilitates cleaning the piping 228 and cleaning or replacing the pump 214. The cutoff valves 246 are attached to a wastewater tee 248 near the pump suction inlet 250, introducing further turbulence into the wastewater flow. The pump's discharge line 220 exits the pump 214 and is directed to further water treatment or disposal means (not shown).

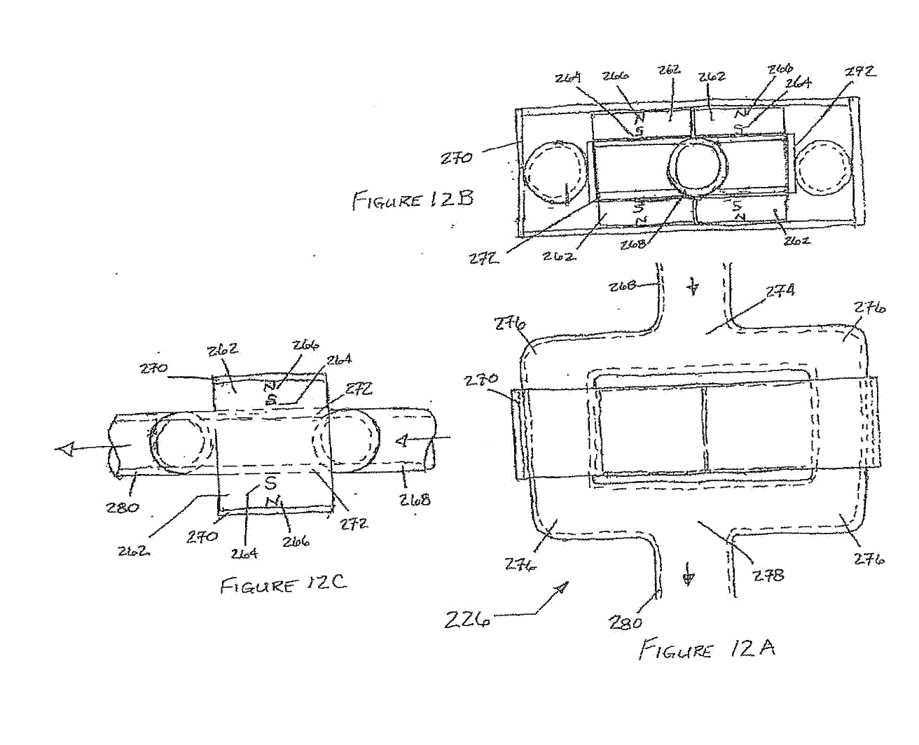

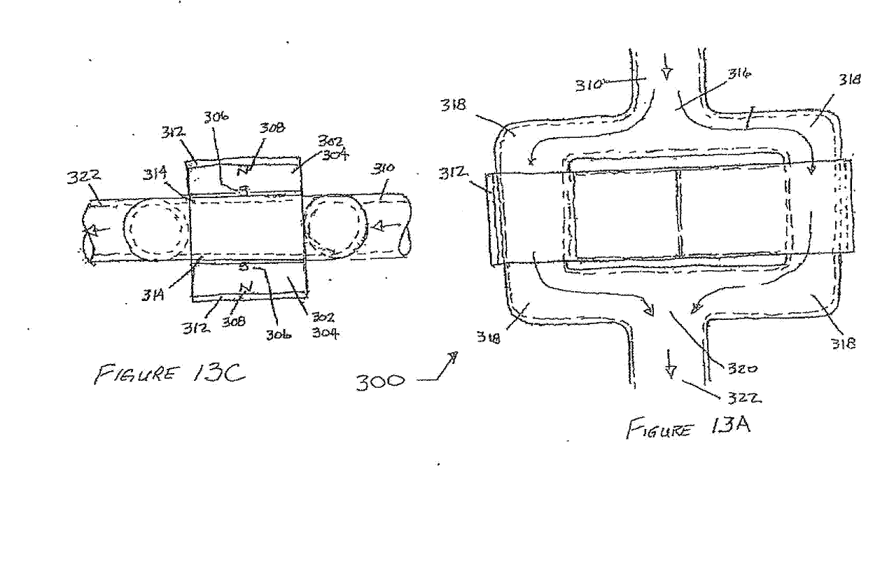

Referring now to FIGS. 12A-C, shown therein is the aligner assembly 226 used in the embodiment of FIG. 10. The aligner assembly 226 contains a plurality of magnets 262, each with its South pole 264 nearest the fluid paths derived from inlet fluid conduit 268. The North poles 266 of the magnets 262 are near a thin-walled exterior rectangular structure 270 made of material with strong magnetic response, such as mild steel plate. This exterior rectangular structure 270 circumscribes the plurality of magnets 262, leaving gaps in selected locations through which fluid entering from the inlet fluid conduit 268 will pass. Preferably, the exterior rectangular structure 270 should be formed without welding or other manufacturing operations which would significantly affect the magnetic properties of the material. The interior rectangular structure 272 is also fabricated from thin-walled material with strong magnetic response, such as mild steel plate. The interior rectangular structure 272, which inscribes the plurality of magnetic field producing means 262, gathers and guides magnetic field emanations from the South magnetic poles 264. Magnets 262 in the present embodiment comprise ferrite permanent magnets, but neodymium or other types of magnet could be used as a matter of design choice.

The inlet fluid conduit 268 arrangement in this aligner unit 226 embodiment provides two paths, or loops, through and immediately adjacent the exterior 270 and interior 272 rectangular structures. A single inlet fluid conduit line 268 is fitted with an inlet side tee 274. The fluid then passes through one of two elbows 276, through one of the gaps between the exterior 270 and interior 272 rectangular structures, through another elbow 276, and then enters the outlet side tee 278 which combines the two fluid paths into a single outlet fluid conduit 280. The fluid conduits 268 and 280, tees 274 and 278, and elbows 276 thus described are preferably composed of a material with little or no magnetic response. Suitable materials include, but are not limited to, PVC plastic, HDPE plastic, copper, or stainless steel.

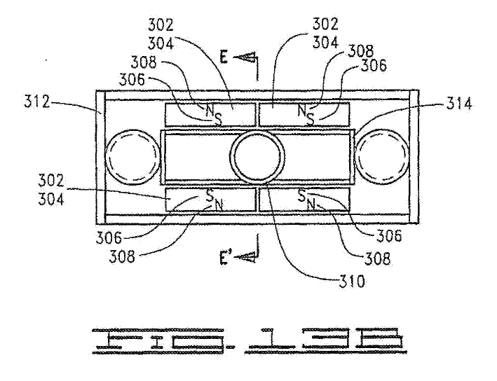

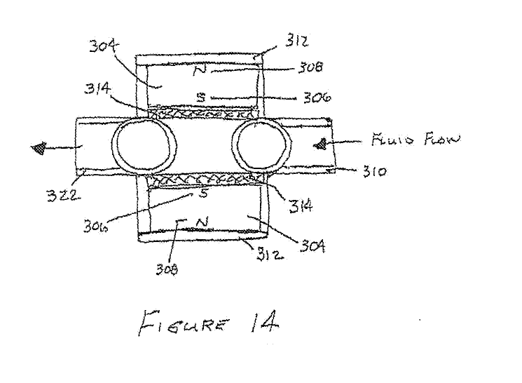

Turning now to FIGS. 13A-C, a fourth embodiment of the present invention is shown which is particularly well adapted for magnetic treatment of domestic water lines. The domestic water treatment unit 300 comprises a plurality of magnets or other magnetic field producing means 302, shown as permanent magnets 304 in the figure. Each of the magnets 304 is arranged with its South 306 pole nearest the fluid paths derived from inlet fluid conduit 310. The North poles 308 of the magnets 304 are near a thin-walled exterior rectangular structure 312 of material with strong magnetic response, such as mild steel plate. This exterior rectangular structure 312 circumscribes the plurality of magnets 304, leaving gaps in selected locations through which fluid entering via the inlet fluid conduit 310 will pass. The exterior rectangular structure 312 should be formed without welding or other manufacturing operations which would significantly affect the magnetic properties of the material. The interior rectangular structure 314 is also fabricated from thin-walled material with strong magnetic response, such as mild steel plate. The interior rectangular structure 314, which inscribes the plurality of magnets 304, gathers and guides magnetic field emanations from the South magnetic poles 306.

As shown in the top view of FIG. 13A, the inlet fluid conduit 310 arrangement in this aligner provides two paths, or loops, through and immediately adjacent the exterior 312 and interior 314 rectangular structures. A single inlet fluid conduit 310 is fitted with an inlet side tee 316, which forces the fluid being treated to take one of two possible paths. After the divided fluid paths have traveled a short distance, the fluid passes through an elbow 318, through the gap between the exterior 312 and interior 314 rectangular structures, through another elbow 318, and then enters the outlet side tee 320 which combines the two fluid paths into a single outlet fluid conduit 322. The fluid conduits 310 and 322, tees 316 and 320, and elbows 318 thus described are preferably composed of a material with little or no magnetic response. Suitable materials include, but are not limited to, PVC plastic, HDPE plastic, copper, and stainless steel.

As may be seen in the side view of FIG. 13B, the South poles 306 of magnets 304 are physically near all portions of the two fluid paths and are physically constrained by the exterior rectangular structure 312 and the interior rectangular structure 314. The exterior 312 and interior 314 rectangular structures are formed of material with a strong magnetic response and carry magnetic flux. In the arrangement of FIGS. 13A-C, in which the magnets 304 are arranged with their South poles 306 immediately adjacent each other and their North poles 308 immediately adjacent each other, repulsive forces would act to separate the magnets 304 unless constrained by external forces. Constraining external forces are exerted by the exterior 312 and interior 314 rectangular structures. The magnets 304 do not move apart because they are forced to remain in place by physical structures, but this does not mean the repulsive magnetic forces vanish. Rather, the repulsive forces still exist and are actually directed in the plane defined by the boundaries of the individual magnets. These forces are at least partially directed into portions of the fluid conduit 310 as determined by the geometric arrangement of the magnets 304.

The front view in FIG. 13C illustrates the presence of two immediately adjacent South pole faces 306, establishing a zone in which fluid molecules experience shear forces fundamental to the busting process. Referring now to FIG. 14, control of the relative dimensions of magnets 304, inner rectangular structure 314, and dimensions of the elbows 318, inlet 316 and outlet 320 tees can enhance the effectiveness of shear forces generated by permanent magnets 304. The busting action of the domestic water treatment unit 300 is enhanced by mechanical turbulence produced at the inlet tee 316, elbows 318, and outlet tee 320.

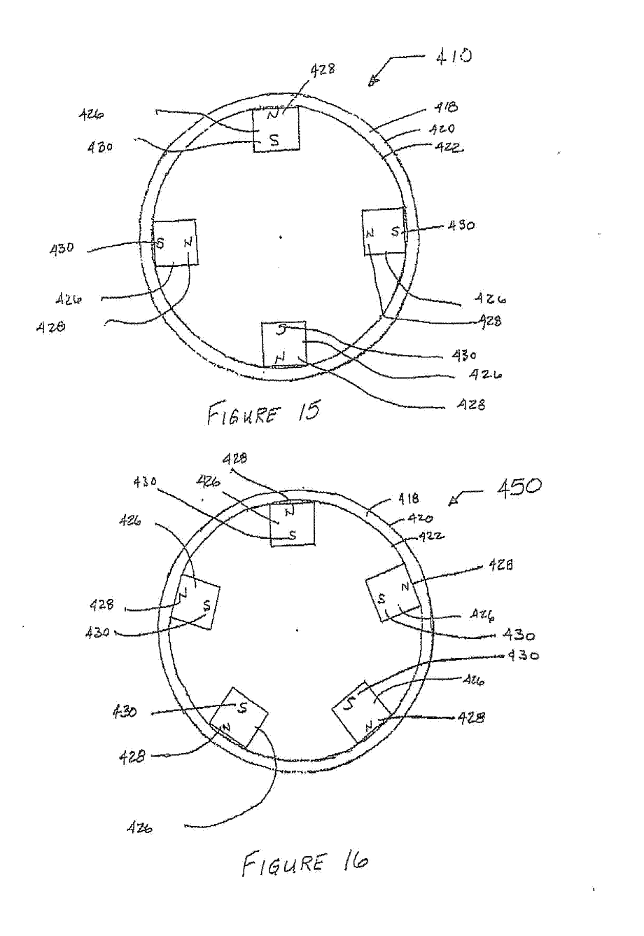

With reference now to FIGS. 15-18, shown therein is a fifth embodiment of the present invention for use with pressurized natural gas fuel lines on large natural gas engines such as those typically used to drive compressor pumps in natural gas pipeline installation. Combustion efficiency and reduction of undesirable exhaust emissions are concerns of particular importance. FIGS. 15 and 16 are sectional drawings of typical buster 410 and aligner 450 assemblies, respectively, which have been used to achieve the desired reduction in combustion byproducts. Referring first to FIG. 15, the higher pressure and larger dimensions of the fuel gas feedline make it necessary to place the treatment unit's 460 magnets 426 directly in the natural gas fuel stream, thereby exposing the fuel gas stream to the highest possible magnetic field. In the present embodiment of FIGS. 15 and 16 there is no inner fluid conduit—the outer sleeve 418 is the structure responsible for confining the natural gas passing through the treatment unit. Preferably, the outer sleeve is made of material having a high magnetic response, typically a mild steel.

Treatment of the natural gas stream fueling a large natural gas internal combustion engine is made more efficient by establishing a nonmagnetic gap between buster and aligner modules, thereby preventing unwanted magnetic interactions between the treatment modules. The necessary gap between buster and aligner modules is achieved using spacers 454 typically made of a material with little or no magnetic field response yet having adequate structural strength to safely confine the pressurized natural gas in the treatment unit. Aluminum is one material with satisfactory material properties for this task, although other suitable materials are available and the use of aluminum is not a limitation of the invention. Buster 410 and aligner 450 modules and associated spacers 454 may be attached to one another by a variety of means readily available to those skilled in the mechanical arts. Details of the connection means are not limitations of the invention.

Improved performance may be achieved using an assembly containing more than one buster module. When two or more buster modules are used, they ordinarily will be radially offset with respect to one other—that is, if one buster module has its magnets mounted in the 12, 3, 6, 9 o'clock positions of the earlier example, additional buster modules should be rotated by a relatively uniform amount to realize a cumulative displacement of approximately 45° relative to the first buster module. Thus, the magnets of a second and succeeding buster modules generally appear in the annular gaps between the magnets of the first buster module when viewed down the bore of the fluid path. This arrangement provides the greatest operating benefit by imparting a twisting moment as well as shearing forces as the gas stream passes through the buster assemblies.

A buster module 410 as used in the fifth embodiment is shown in cross-section in FIG. 15. The buster module 410 features an outer sleeve 418, shown as a section of pipe with circular cross-section for purposes of illustration. Outer sleeve 418 has an outer wall 420 and an inner wall 422. Outer sleeve 418 will ordinarily be made of mild steel or other material with a strong magnetic response. Outer sleeve 418 should be formed without welding or other high-heat fabrication operations. A plurality of magnetic field producing means 426, preferably an even number, are affixed substantially adjacent the inner wall 422 of outer sleeve 418. More preferably, four magnets 426 are used and shown as bar-type permanent magnets. Magnets 426 are arranged with their respective major axes parallel to the axis of outer sleeve 418. The magnets 426 are arranged in a radially symmetric equidistantly spaced relationship. Each magnet 426 has a North pole 428 and a South pole 430. The radially outermost pole faces of the magnets 426 are maintained in close proximity to the inner wall 422 of outer sleeve 418.

Buster module 410 magnets 426 are arranged to present alternating polarities to the outer sleeve 418. In FIG. 15, the uppermost magnets 426 presents its North pole 428 to outer sleeve 418. Proceeding from this location in a clockwise manner, it is seen that the subsequent three magnets 426 present a South pole 430, a North pole 428, and a South pole 430, respectively, to outer sleeve 418. Preferably, magnets 426 in a buster module 410 ordinarily will be devices having the same nominal dimensions and will be of the same type.

A detailed description of a representative aligner module 450 as used in the fifth embodiment is shown in cross-section in FIG. 16. An aligner module 450 is frequently, but not necessarily, structurally similar to a buster module 410, with the primary difference between the two module types being the orientation of the magnets 426. For this reason, many of the same reference numerals are used in the buster module 410 description above and the aligner module 450 description which follows.

Aligner module 450 features an outer sleeve 418, shown as a section of pipe with circular cross-section for purposes of illustration. Outer sleeve 418 has an outer wall 420 and an inner wall 422. Outer sleeve 418 will ordinarily be made of a mild steel or other material with a strong magnetic response. Outer sleeve 418 should be formed without welding or other high-heat fabrication operations. A plurality of magnets 426, which may be either an even or an odd number, are affixed substantially adjacent the inner wall 422 of outer sleeve 418. Preferably, five magnets 426 are used and shown as bar-type permanent magnets. Magnets 426 are preferably arranged with their respective major axes parallel to the axis of outer sleeve 418 in a radially symmetric equidistantly spaced relationship. Each magnet 426 has a North pole 428 and a South pole 430. The radially outermost pole faces of the magnets 426 are maintained in close proximity to the inner wall 422 of outer sleeve 418.

Aligner module 450 features magnets 426 arranged to present the same polarity to the outer sleeve 418. In FIG. 16, all magnets 426 present their North pole 428 to fluid conduit 418. Preferably, the magnets 426 in an aligner module 450 ordinarily will be devices having the same nominal dimensions and will be devices of the same type.

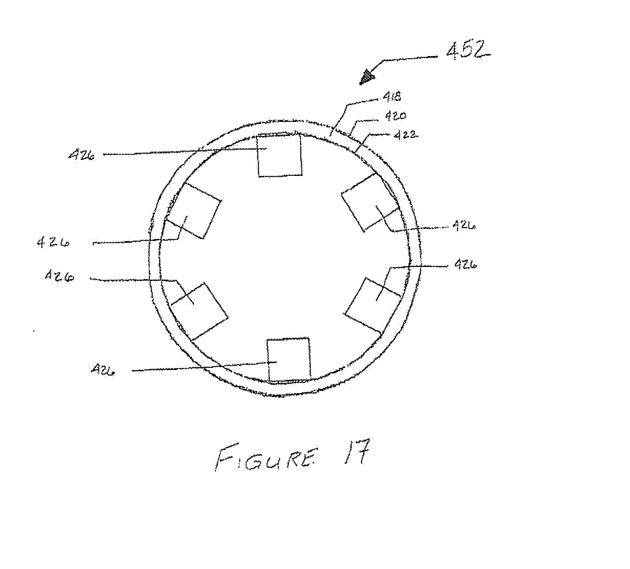

FIG. 17 is a cross-sectional view of a representative six-element module 452 which may be configured as either a buster or aligner module when constructed in accordance with this invention. The module has an outer sleeve 418 with an outer wall 420 and an inner wall 422. Six magnets 426 are arranged with their respective major axes parallel to the axis of the outer sleeve 418 in a radially symmetric equidistantly spaced relationship. Each magnet 426 has a North pole 428 (not shown) and a south pole 430 (not shown) separated by a magnetic equator (not shown). The functional behavior of the six-element module 452 will be determined by the relationship of the North poles 428 and south poles 430 with respect to the inner wall 422 of outer sleeve 418.

If the six magnets 426 are imagined to correspond to 12, 2, 4, 6, 8, and 10 o'clock on a clock face, the construction of FIG. 17 may be configured as a six-element buster module by orienting the magnets 426 such that the North poles 428 in the 12, 4, and 8 o'clock positions are nearest the inner wall 422 of outer sleeve 418 and the South poles 430 in the 2, 6, and 10 o'clock positions are nearest the inner wall 422 of outer sleeve 418. A six-element buster configuration is also obtained by orienting the magnets 426 such that North poles 428 in the 2, 6, and 10 o'clock positions are nearest the inner wall 422 of outer sleeve 418 and the South poles 430 in the 12, 4, and 8 o'clock positions are nearest the inner wall 422 of outer sleeve 418. From this it is evident that one essential feature of the buster structure is the radially alternating polarity of the magnet 426 poles located nearest the inner wall 422 of the outer sleeve 418. The exact location of North poles 428 and South poles 430 with respect to an arbitrary reference location is achieved by rotation of the essential buster structure.

The six-element module also may be configured as an aligner. As before, each magnet 426 has a North pole 428 and a South pole 430. If the six magnets 426 in FIG. 17 are oriented such that all North poles 428 are nearest the inner wall 422 of outer sleeve 418, then the six-element module is configured as an aligner of a type usually for use in the Northern hemisphere. If the six magnets are oriented such that all South poles 430 are nearest the inner wall 422 of outer sleeve 418, then the six-element module is configured as an aligner of a type usually for use in the Southern hemisphere.

As is evident from the detailed description above, it is meaningful to describe not only a magnetic fluid treatment module's dimensions, materials, and function (buster or aligner) but also the number and type of magnets 426 employed in the module's construction. For purposes of illustration, the detailed construction of the present embodiment describes a fluid treatment assembly typically installed on a 2-inch diameter natural gas line. In this example, circular cross-section, a regularly spaced apart relationship between the magnets (permanent magnets) and use of multiple magnets of consistent dimensions are understood. Thus, the entry “3-inch diameter 4-inch long six-element neodymium buster” will be understood to describe a six-element circular configuration with total length of four inches and nominal diameter of substantially three inches constructed according to FIG. 17 using six neodymium permanent magnets in a regularly spaced-apart relationship with the North and South poles, 428 and 430 respectively, being oriented such that North poles 428 and South poles 430 are alternately nearest the inner wall 422 of outer sleeve 418.

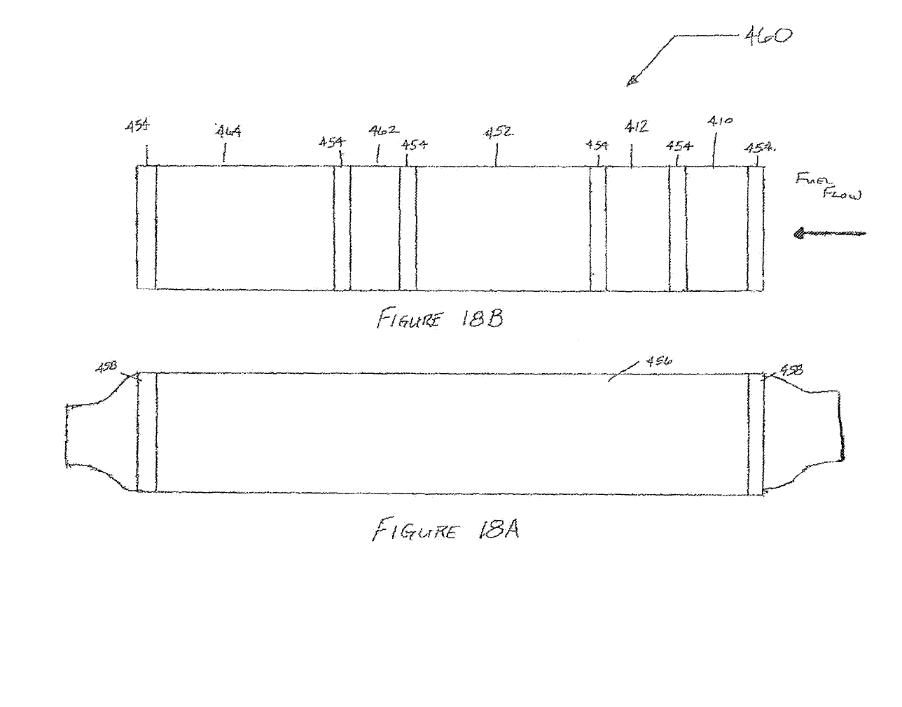

The embodiment 460 of the present invention used to treat a 2-inch diameter natural gas line is shown in side view in FIG. 18A. Fuel, natural gas in the fifth embodiment, enters the fuel treatment assembly 460 from the right. The fuel treatment unit 460 is provided with threaded adapters 458 at each end of the fuel treatment unit 460 to facilitate installation in the fuel line. Because natural gas installations of this type may be pressurized to 40 psia or more, the entire fuel treatment assembly 460 is encased in a pressure jacket 456 made from a material such as stainless steel or aluminum. Ideally, pressure jacket 456 will have magnetic permeability of substantially unity, although the ability to contain a pressure rupture in the fuel treatment assembly 460 is of primary importance. Threaded reducing adapters 458 are securely attached to the pressure jacket 456 by welding or by another manufacturing process assuring a permanent, tight, leak-proof joint. Threaded reducing adapters 458 may be of a type adapting a three-inch diameter treatment unit to a two-inch diameter natural gas feed line, as shown in FIG. 18A, but the use of adapters between different pipe diameters is not a limitation of the invention.

Referring to FIG. 18B, as fuel enters the fuel treatment unit 460 from the right, it passes through a first ⅜-inch long aluminum spacer 454, a first 1½-inch long six-element neodymium buster 410, a second ⅜-inch long aluminum spacer 454, a second 1½-inch long six-element neodymium buster 412 rotated approximately 30° with respect to first buster 410, a third ⅜-inch long aluminum spacer 454, a first 4¼-inch long four-element ferrite buster 452, a fourth ⅜-inch long aluminum spacer 454, a first 1½-inch long five element neodymium aligner 462, a fifth ⅜-inch long aluminum spacer 454, a first 4¼-inch long five-element ferrite aligner 464, and a sixth ⅜-inch long aluminum spacer 454.

Spacers 454 are preferably formed of aluminum or other material with magnetic permeability of substantially unity. The use of aluminum for spacers 454 is not a limitation of the invention.

In the present embodiment, busters 410, 412, and 452, aligners 462 and 464, and spacers 454 are held in position by adhesives. This is a matter of manufacturing convenience and is not a limitation of the invention. For example, busters 410, 412, and 452, aligners 462 and 464, and spacers 454 could also be held in position by threaded engagements, coupling unions, pins and gaskets, or other joining features known in the mechanical arts. Only welding, soldering, brazing, or other high-heat operations are discouraged.

Once installed in the pressure jacket 456 (with threaded adapters 458 welded or otherwise securely attached in a gas-tight manner to the pressure jacket 456), failure of an adhesive bond, threaded fitting, gasket, or other joint will not result in a dangerous leak because the natural gas being treated will continue to be confined by pressure jacket 456 and associated threaded adapters 458.

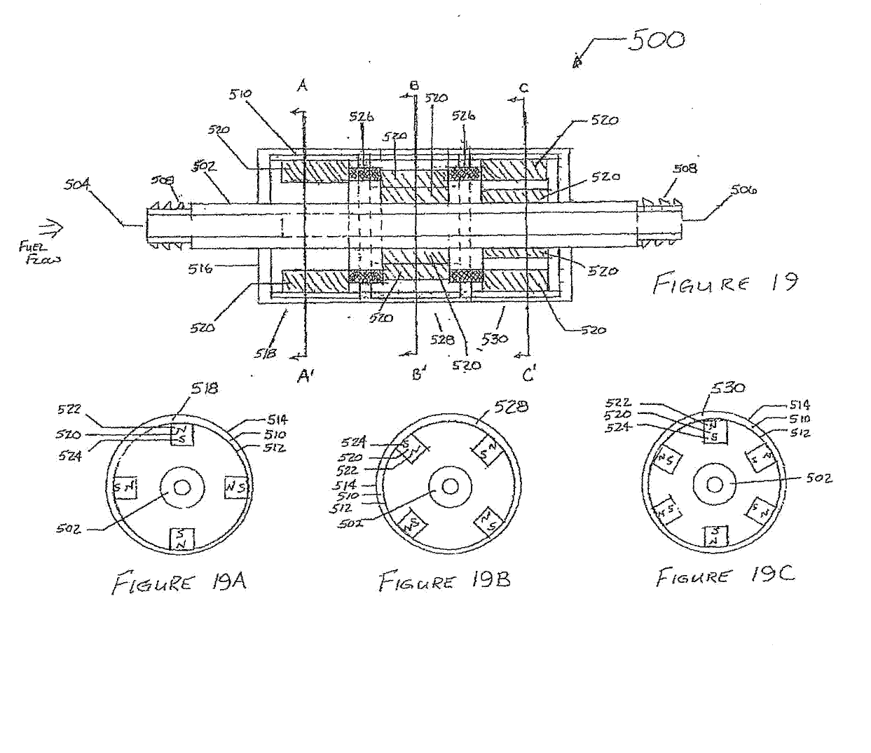

With reference now to FIG. 19, shown therein is the sixth embodiment of this invention, an alternative fluid treatment device preferred for use with highly refined hydrocarbon liquids—gasoline, for example. Treatment of such liquids may greatly reduce such exhaust emissions as carbon particulates (C), carbon monoxide (CO), and various oxides of nitrogen (NOₓ).

Shown in FIG. 19 is a magnetic fluid treatment device 500 particularly well suited to the treatment of gasoline prior to combustion in small gasoline engines. Fuel flows through the fuel treatment assembly 500 in an inner fluid conduit 502 having an inlet end 504 and an outlet end 506. Inner fluid conduit 502 is made of material having weak magnetic response (relative permeability of substantially unity) typically copper, stainless steel, aluminum, or certain engineering plastics suitable for use with gasoline. Fuel treatment unit 500 is adapted with barbed fittings 508 at inlet end 504 and at outlet end 506 to facilitate installation in a gasoline fuel line (not shown).

Gasoline in the inner fluid conduit 502 initially passes through first buster 518 consisting of four magnets 520 mounted inside an outer sleeve 510. Outer sleeve 510 is made of material having a strong ferromagnetic response (relative permeability much greater than unity), typically a mild steel, although use of mild steel is a matter of design choice. Other materials such as nickel would be equally acceptable for use as the outer sleeve 510. Outer sleeve 510 has an inner wall 512 and an outer wall 514. In the sixth embodiment, four permanent magnets 520, each having a North pole 522 and a South pole 524, are securely attached immediately adjacent the inner wall 512 of outer sleeve 510. In one embodiment, magnets 520 are neodymium permanent magnets, but this is a matter of design choice and is not a limitation of the invention. Other types of magnets may be used.

Assuming the magnets 520 in first buster 518 are oriented as shown in Section A-A′ of FIG. 19A, the locations of magnets 520 may be described using the analogous positions of 12, 3, 6, and 9 o'clock on a conventional clock face. In the first buster module 518, as shown in Section A-A′, the North poles 522 of magnets 520 in the 12 o'clock and 6 o'clock positions are mounted nearest the inner wall 512 of outer sleeve 510. South poles 524 of magnets 520 in the 3 o'clock and 9 o'clock positions are mounted nearest the inner wall 512 of outer sleeve 510.

As shown in FIG. 19B, Section B-B′, the arrangement of magnets 520 in second buster 528 are rotated approximately 45° relative to the magnets 520 in first buster 518. With the exception of this rotation, first buster 518 and second buster 528 of the present embodiment are identical. However, it is not necessary for first buster 518 and second buster 528 to have the same number of magnets 520, nor is it necessary that all magnets 520 be of the same type and dimensions. Number, size, type, and geometry of each buster are matters of design choice, as previously taught.

It is desirable to have a slight nonmagnetic gap between the outer sleeves 510 of first buster 518 and second buster 528. This gap is provided by first spacer 526, a nonmagnetic object arranged to maintain a gap between the outer sleeves 510 of first buster 518 and second buster 528. Spacer 526 is a short length of commercially available Schedule 40 PVC tubing, but it may be composed of any non-magnetic material having relative permeability of substantially unity. Spacer 526 normally will be made of electrically insulating material, but this is not a limiting consideration. Spacer 526 must be hollow with an annulus sufficiently large to pass inner fluid conduit 502 therethrough. Suitable materials for use as spacer 526 would be aluminum, any number of plastics (PVC, HDPE, polyurethanes, nylon, and the like), or materials such as phenolics. These are matters of design choice and are not limitations of the invention. Dimensions of spacer 526 are such that the outside diameter of spacer 526 is slightly smaller than the inside diameter of outer sleeves 510, thereby allowing spacer 526 to project slightly inside the outer sleeves 510 before abutting the ends of magnets 520 inside first buster 518 and second buster 528.

The final modular treatment is a first aligner module 530. For convenience, assume the magnets 520 in first aligner 530 are oriented as shown in Section C-C′ of FIG. 22C. In the present embodiment, six magnets 520 are used in aligner 530. The locations of magnets 520 may be described using the analogous positions of 12, 2, 4, 6, 8, and 10 o'clock on a conventional clock face. In first aligner module 530, shown in Section C-C′ and corresponding to a construction for use in the Northern hemisphere, all North poles 522 of magnets 520 are mounted nearest the inner wall 512 of outer sleeve 510. In the present embodiment, outer sleeve 510 of first aligner 530 is made of the same material used in first buster 518 and second buster 528 and has the same dimensions as outer sleeves 510 of first buster 518 and second buster 528.

It is desirable to have a slight nonmagnetic gap between the outer sleeves 510 of second buster 528 and first aligner 530. As done to establish the nonmagnetic gap between first buster 518 and second buster 528, the desired gap is established by second spacer 526, a second nonmagnetic object arranged to maintain a gap between outer sleeves 510 of second buster 528 and first aligner 530. In the present embodiment, all spacers 526 are short lengths of commercially available Schedule 40 PVC tubing and are interchangeable. As previously discussed, spacers 526 may be composed of any non-magnetic material having relative permeability of substantially unity. Dimensions of spacer 526 in the present embodiment are such that the outside diameter of spacer 526 is slightly smaller than the inside diameter of outer sleeves 510, thereby allowing spacer 526 to project slightly inside the outer sleeves 510 before abutting the ends of magnets 520 inside first buster 518 and second buster 528. This feature provides manufacturing advantages, but is not a limitation of the invention.

First buster 518, second buster 528, and first aligner 530 are held in position within an outer jacket (not shown) by silicone, glue, epoxy, or similar encapsulants or adhesives. Use of adhesives or encapsulants is a matter of manufacturing convenience and is not to be considered a limitation of the invention. For example, first buster 518, second buster 528, and first aligner 530 could also be held in position by threaded engagements, coupling unions, pins and gaskets, plastic members, or other joining and positioning feature known in the mechanical arts. Only welding, soldering, brazing, and other high-heat operations are discouraged.

The entire fuel treatment unit 500 is encased in an outer jacket 516 made from a material such as brass, aluminum, stainless steel, or selected engineering plastics approved for use with gasoline. Outer jacket 516 exists to protect and help maintain proper alignment of the magnetic treatment unit components previously discussed. In addition, the outer jacket 516 may be formed with mounting features to assist in securing the fuel treatment unit 500 to the engine-powered unit on which it will be used.

Several closely-related variations of the sixth embodiment are possible, although all are very similar in appearance and construction to the apparatus shown in FIG. 19. Variations in the general design of the present embodiment arise from such considerations as total volume of fuel flow, mounting considerations, and other operational details which make it desirable to adapt a single basic design to suit particular application circumstances. In the particular variant of this embodiment intended for use with small gasoline engines, inner fluid conduit 502 is a section of stainless steel tubing (⅜-inch trade size) which has 7/16-inch i.d. and ⅝-inch o.d. Outer sleeve 510 used to fabricate first buster 518, second buster 528, and first aligner 530 is 1 13/16-inch o.d. mild steel pipe cut to a length of 1⅛-inch. All magnets 520 are ¼-inch wide, ⅜-inch high, and ¾-inch long neodymium magnets. Each of the spacers 526 are made from Schedule 40 PVC pipe cut to a length of ⅜-inch. First buster 518, first spacer 526, second buster 528, second spacer 526, and first aligner 530 are held together by silicone, glue, or epoxy. Assembly of the small gasoline engine variant is completed by sliding the inner fluid conduit 502 through the annulus of the buster-spacer-buster-spacer-aligner assembly and filling all voids with silicone. When cured, this treatment assembly is installed in a plastic exterior jacket 516 having 1⅝-inch i.d. and 1⅞-inch o.d.

A slightly larger variant is contemplated for use in automotive applications for passenger automobiles and trucks. The inner fluid conduit 502 used on the automotive variant is ½-inch trade size stainless steel tubing having ⅝-inch i.d. and 13/16-inch o.d. Inlet end 504 and outlet end 506 are adapted to existing fuel lines by threaded ends rather than barbed fitting. In the automotive variant, outer sleeve 510 used to fabricate first buster 518, second buster 528, and first aligner 530 is made from 2-inch i.d., 2¼-inch o.d. mild steel pipe cut to a length of 1⅛-inch. All magnets 520 are ½-inch wide, ¼-inch high, and 1-inch long neodymium magnets. Each of the spacers 526 are made from Schedule 40 PVC pipe cut to a length of ⅜-inch. First buster 518, first spacer 526, second buster 528, second spacer 526, and first aligner 530 are held together by silicone, glue, or epoxy. Assembly of the automotive variant is completed by sliding the inner fluid conduit 502 through the annulus of the buster-spacer-buster-spacer-aligner assembly and filling all voids with silicone. When cured, this treatment assembly is installed in an aluminum exterior jacket 516.

One skilled in the art will appreciate the number, type, and composition of magnets are matters of design choice. Materials and dimensions of the materials used as outer sleeves, outer jackets, spacers, fluid conduits, and other structural elements are likewise matters of design choice.

1. An assembly for magnetically treating a fluid, comprising:
a first buster module and a second buster module, each of the first and second buster module comprising:
an outer sleeve;
an inner fluid conduit having a central axis;
four magnets each having a first pole and a second opposite pole, the poles separated by a magnetic equator and the magnets being spaced apart;
wherein the conduit is disposed within the sleeve forming an annular space between the conduit and the sleeve;
wherein the magnets are symmetrically disposed in the annular space with their magnetic equators parallel to the central axis of the conduit; and
wherein the magnets are oriented such that, for any magnet disposed such that its first pole is positioned adjacent the conduit, an adjacent magnet is disposed such that its second pole is positioned adjacent the conduit;
wherein an alignment of the first buster module is rotationally offset from an alignment of the second buster module; and
at least one aligner module, each aligner module comprising:
an outer sleeve;
an inner fluid conduit having a central axis;
an odd number magnets each having a first pole and a second opposite pole, the poles separated by a magnetic equator;
wherein the conduit is disposed within the sleeve forming an annular space between the conduit and the sleeve; and
wherein the magnets are symmetrically disposed in the annular space with their magnetic equators parallel to the central axis of the conduit; and
wherein the magnets are oriented such that each magnet has the same first pole or second pole placed nearest the conduit.

2. The assembly of claim 1 wherein the alignment of the first buster module is rotationally offset by an angle of 0 to 45 degrees from the alignment of the second buster module.

3. The assembly of claim 1 wherein the aligner module comprises an odd number of at least three magnets.

4. The assembly of claim 1 further comprising two aligner modules wherein each aligner module comprises magnets that have the same first pole or second pole placed nearest the conduit.

5. The assembly of claim 1 wherein the fluid conduit is made of material having magnetic permeability of substantially unity.

6. The assembly of claim 5 wherein the outer sleeves are made of material having magnetic permeability greater than unity.

7. The assembly of claim 1 wherein the magnets are electromagnets.

8. The assembly of claim 1 wherein the fluid conduit comprises an inlet fitting and an outlet fitting.

9. The assembly of claim 8 wherein the first buster module is proximate the inlet fitting and the second buster module is proximate the outlet fitting, wherein the second buster module is rotated about the fluid conduit with respect to the first buster module.

10. The assembly of claim 9 wherein the second buster module is rotationally offset by an angle of 0 to 45 degrees relative to the first buster module.

11. The assembly of claim 1 further comprising a third buster module wherein an alignment of the third buster module is rotationally offset from the first buster module.

12. The assembly of claim 11 wherein the first buster module, second buster module, and third buster module are each rotationally offset in approximately equal increments.

13. The assembly of claim 12 wherein the cumulative angle of rotation of the third buster module with respect to the first buster module is greater than 45 degrees.
